(19) United States
(12) Patent Application Publication
(10) Pub. No.: US 2024/0065452 A1
(43) Pub. Date: Feb. 29, 2024

(54) SIDE OBJECT-HOLDING DEVICE, CONNECTION MECHANISM, CANOPY STRUCTURE, AND CARRIER

(71) Applicant: Wonderland Switzerland AG, Steinhausen (CH)

(72) Inventors: Xiaolong MO, Dongguan (CN); Xiong YU, Dongguan (CN)

(73) Assignee: Wonderland Switzerland AG, Steinhausen (CH)

(21) Appl. No.: 18/454,326

(22) Filed: Aug. 23, 2023

(30) Foreign Application Priority Data
Aug. 23, 2022 (CN) 202211015209.6
Mar. 3, 2023 (CN) 202310202116.2

(51) Int. Cl. A47D 15/00; A47D 13/02

(52) U.S. Cl. CPC A47D 15/00; A47D 13/027

(57) ABSTRACT

The present disclosure relates to a side object-holding device, a connection mechanism, a canopy structure, and a carrier. The side object-holding device includes an object holder and a first mounting assembly. The object holder has an object-holding cavity. The first mounting assembly is arranged on an outer wall of the object holder, and the object holder is mounted on an outer side of a rotational joint of the carrier through the first mounting assembly. In the above side object-holding device, the object holder can be mounted on the outer side of the rotational joint of the carrier through the first mounting assembly.

### CROSS-REFERENCE TO RELATED APPLICATIONS

This application claims priority to Chinese Patent Application No. 2022110152096, filed on Aug. 23, 2022, titled “SIDE OBJECT-HOLDING DEVICE AND CARRIER”, and Chinese Patent Application No. 202310202116.2, filed on Mar. 3, 2023, titled “CONNECTION MECHANISM APPLIED IN CANOPY ASSEMBLY, CANOPY STRUCTURE, AND CHILD CARRIER”, the contents of which are hereby incorporated by reference in its entirety.

### TECHNICAL FIELD

The present disclosure relates to the technical field of carriers, and in particular, to a side object-holding device, a connection mechanism, a canopy structure, and a carrier.

### BACKGROUND

Carriers, for example, infant carriers such as carry-cots and child safety seats, greatly facilitate travel of infants and young children, and largely guarantee safety of infants and young children. However, these infant carriers generally lack an object-holding function, which cannot meet needs of users to place personal items such as mobile phones and water cups.

### SUMMARY

The present disclosure provides a side object-holding device applied to a carrier and including an object holder and a first mounting assembly. The object holder has an object-holding cavity. The first mounting assembly is arranged on an outer wall of the object holder, and the object holder is mounted on an outer side of a rotational joint of the carrier through the first mounting assembly. The object holder is detachably mounted on the outer side of the rotational joint of the carrier through the first mounting assembly.

The present disclosure further provides a carrier. The carrier includes a rotational joint, a second mounting assembly and a side object-holding device. The second mounting assembly arranged on an outer side of the rotational joint. The side object-holding device includes an object holder and a first mounting assembly. The first mounting assembly is arranged on an outer wall of the object holder. The object holder is capable of being mounted on the outer side of the rotational joint through cooperation between the first mounting assembly and the second mounting assembly.

The present disclosure further provides a canopy structure. The canopy structure includes a mounting base, a canopy assembly and a connection mechanism. The canopy assembly is connected to a mounting base and unfolded or folded with pivoting of the mounting base. The connection mechanism includes a connector, a first fixing member and a second fixing member. The connector has a connecting portion and a fixing portion spaced apart. The connecting portion is configured to be connected to one of the canopy assembly and the mounting base. The first fixing member is arranged on the fixing portion. The second fixing member arranged on the other of the canopy assembly and the mounting base and detachably connected to the first fixing member.

### BRIEF DESCRIPTION OF THE DRAWINGS

FIG. 1 is a schematic structural diagram of a carrier according to an embodiment of the present disclosure, where an opening of an object holder is in a state facing upwards;

FIG. 2 is a side view of the carrier shown in FIG. 1;

FIG. 3 is another schematic structural diagram of the carrier according to an embodiment of the present disclosure, where the opening of the object holder is in a state facing backwards;

FIG. 4 is a schematic structural diagram of the carrier shown in FIG. 1 after removal of a carrier body;

FIG. 5 is an enlarged view of portion A in FIG. 4;

FIG. 6 is an exploded view of FIG. 4;

FIG. 7 is another exploded view of FIG. 4;

FIG. 8 is a schematic structural diagram of the carrier shown in FIG. 4 after further removal of a side object-holding device on one side;

FIG. 9 is an enlarged view of portion B in FIG. 8;

FIG. 10 is a schematic structural diagram of the side object-holding device shown in FIG. 4;

FIG. 11 is a sectional view of FIG. 4;

FIG. 12 is an enlarged view of portion C in FIG. 11;

FIG. 13 is a sectional view of FIG. 8;

FIG. 14 is an enlarged view of portion D in FIG. 13;

FIG. 15 is an exploded view of the carrier after removal of a carrier body and a side object-holding device on one side according to another embodiment;

FIG. 16 is an enlarged view of portion E in FIG. 15;

FIG. 17 is an exploded view of the carrier after removal of a carrier body and a side object-holding device on one side according to yet another embodiment;

FIG. 18 is an enlarged view of portion F in FIG. 17;

FIG. 19 is a schematic structural diagram of a carrier according to a further embodiment of the present disclosure, in which cloth is in an unfolded state;

FIG. 20 is a schematic structural diagram of the carrier in FIG. 19, in which the cloth is in a folded state;

FIG. 21 is a schematic structural diagram of the carrier in FIG. 19 in another viewing direction, in which the cloth is in the unfolded state;

FIG. 22 is a schematic structural diagram of the carrier in FIG. 19 in yet another perspective, where the cloth is in the folded state;

FIG. 23 is a partial enlarged view of a carrier according to a first embodiment when part of the cloth is opened at portion G in FIG. 19, where a first snap button is engaged with a second snap button;

FIG. 24 is a partial enlarged view of the carrier according to the first embodiment when part of the cloth is opened at portion G in FIG. 19, where the first snap button is disengaged from the second snap button;

FIG. 25 is a partial enlarged view of a carrier according to a second embodiment when part of the cloth is opened at portion G in FIG. 19, where a first hook and loop fastener is bonded to a second hook and loop fastener;

FIG. 26 is a partial enlarged view of the carrier according to the second embodiment when part of the cloth is opened at G in FIG. 19, where the first hook and loop fastener is debonded from the second hook and loop fastener;

FIG. 27 is a partial enlarged view of a carrier according to a third embodiment when part of the cloth is opened at portion Gin FIG. 19, where a fixing post is in insertion fit with a fixing hole;

FIG. 28 is a partial enlarged view of the carrier according to the third embodiment when part of the cloth is opened at portion Gin FIG. 19, where the fixing post is out of insertion fit with the fixing hole; and

FIG. 29 is a schematic diagram of a connector.

### REFERENCE SIGNS

100: side object-holding device, 110: object holder, 111: object-holding cavity, 112: ventilation hole, 120: first mounting assembly, 121: engaging protrusion, 122: engaging border, 1221: arc-shaped portion, 1222: first strip-shaped portion, 1223: second strip-shaped portion, 1224: limiting protrusion, 123: limiting rib,
200: carrier body/carry-cot body,
300: handle,
400: rotational joint, 410: joint body, 411: rotating portion, 4111: annular bulge, 412: mounting portion, 413: insertion slot, 420: decorative cover, 421: decorative cover body, 422: annular hook, 430: rotating shaft, 431: pin portion, 432: abutting portion, 440: operation button,
500: second mounting assembly, 510: mounting protrusion, 511: first side edge, 512: second side edge, 513: arc-shaped edge, 520: stop ring, 530: connecting portion, 540: engaging gap;
600: canopy structure, 610: mounting base, 620: canopy assembly, 621: canopy bracket, 622: cloth, 6221: first piece of cloth, 6222: second piece of cloth, 6223: fastener, 6224: bottom corner, 630: connection mechanism, 631: connector, 6311: connecting portion, 6312: fixing portion, 632: first fixing member, 632a: first snap button, 6321: male fastening portion, 6322: pressing surface, 632b: first hook and loop fastener, 632c: fixing hole, 633: second fixing member, 633a: second snap button, 633b: second hook and loop fastener, 633c: fixing post, 6331: female fastening portion.

### DETAILED DESCRIPTION OF THE EMBODIMENTS

In order to make the objectives, technical solutions, and advantages of the present disclosure clearer, the present disclosure will be further described in detail below in conjunction with the accompanying drawings and specific implementations. It should be understood that the specific implementations described herein are intended only to explain the present disclosure, and do not limit the protection scope of the present disclosure.

It is to be noted that, when one element is referred to as “fixed to” another element, it may be directly disposed on the another element or an intermediate element may exist. When one element is considered to be “connected to” another element, it may be directly connected to the another element or an intermediate element may co-exist. The terms “vertical”, “horizontal”, “left”, “right” and similar expressions used herein are for illustrative purposes only, and do not indicate a unique implementation.

Unless defined otherwise, all technical and scientific terms used herein have the same meanings as would generally understood by those skilled in the technical field of the present disclosure. The terms used herein in the specification of the present disclosure are for the purpose of describing specific embodiments only, and are not intended to limit the present disclosure. The term “and/or” used herein includes any and all combinations of one or more related listed items.

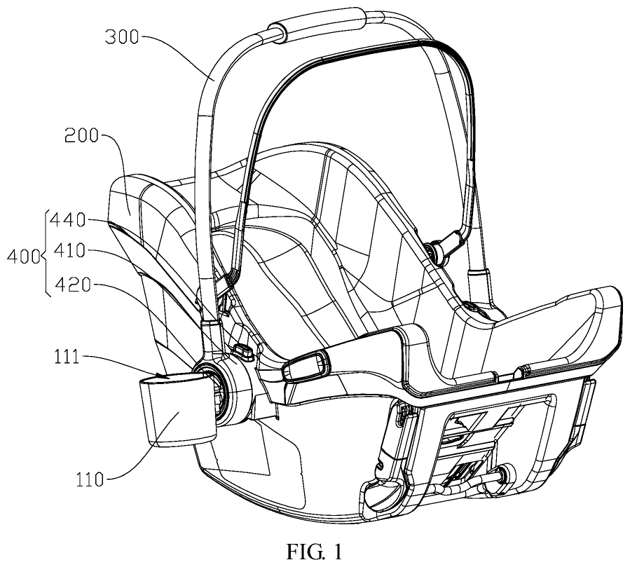

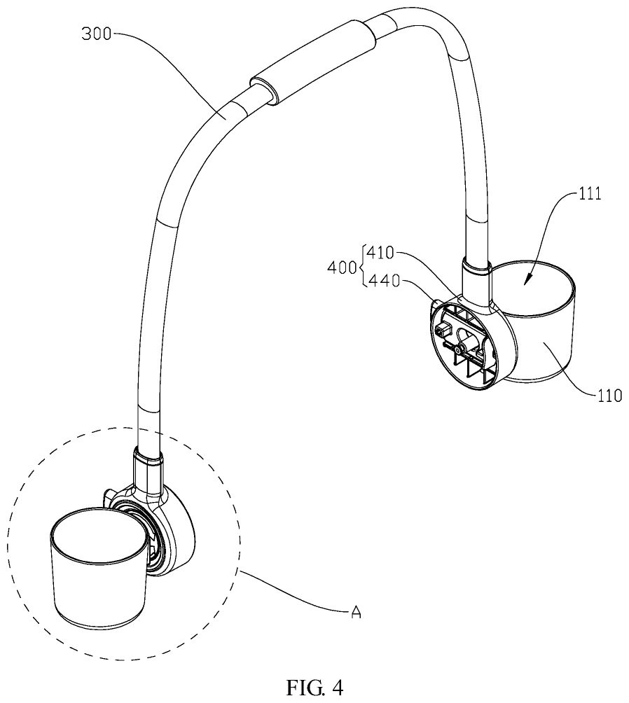

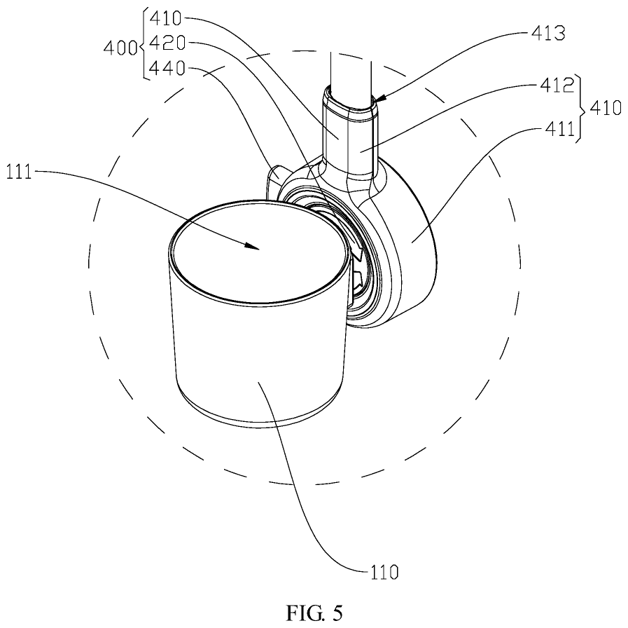

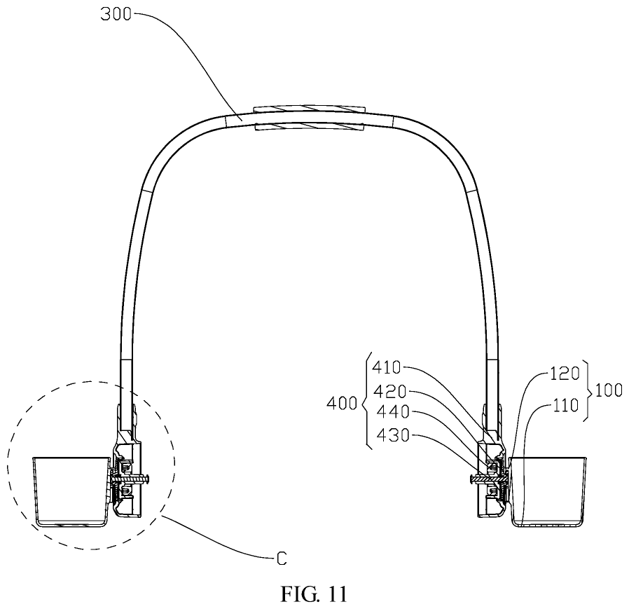

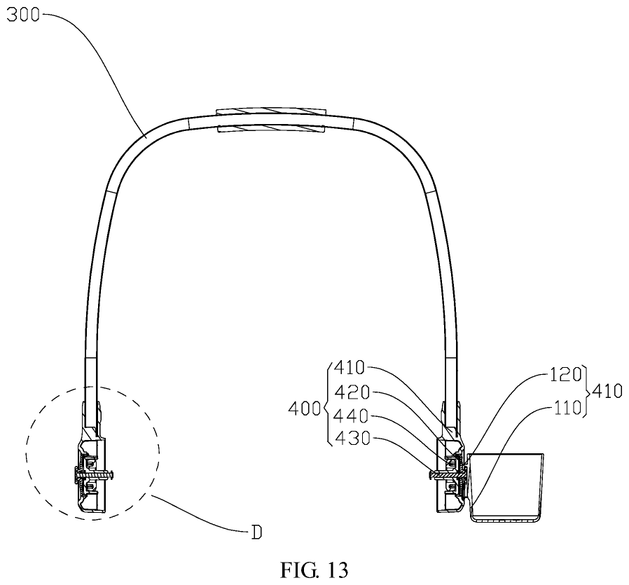

As shown in FIG. 1 to FIG. 18, in a first aspect, the present disclosure proposes a carrier, which may be an infant carrier, a pet carrier, or the like. In this embodiment, the carrier is a carry-cot. The carrier is convenient for a user to place items, and can have a certain impact resistance effect. In other embodiments, the carrier may be a stroller, a baby sleeping box, or the like.

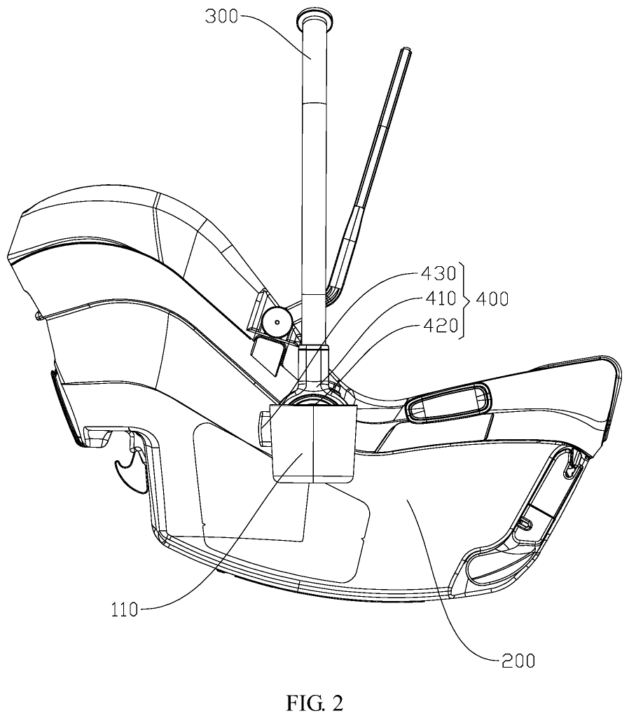

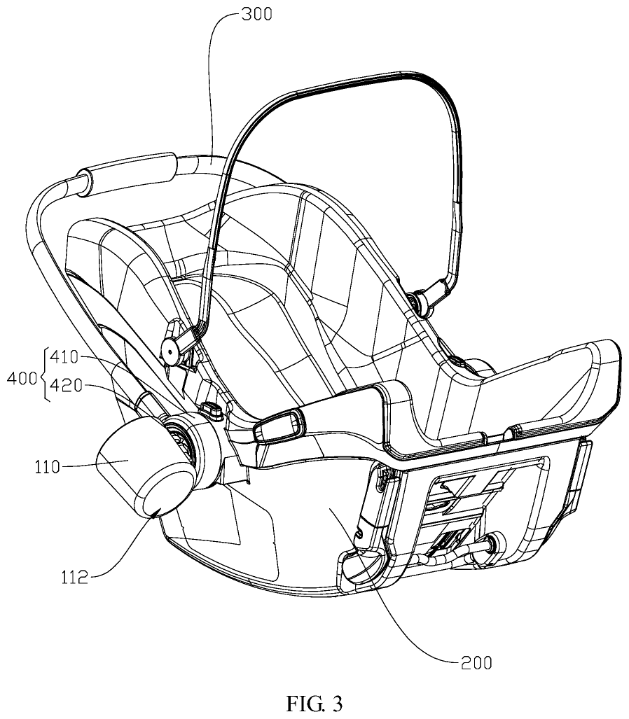

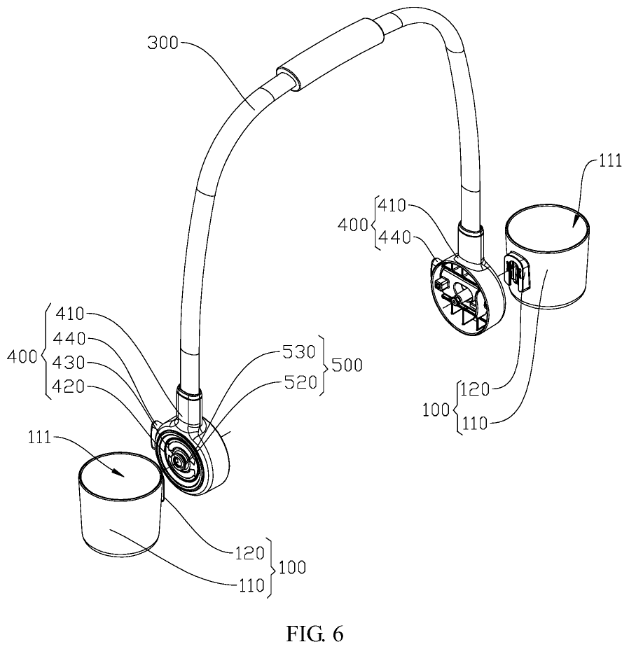

Specifically, as shown in FIG. 1 to FIG. 6, the carrier includes a side object-holding device 100, a carrier body 200, a handle 300, a rotational joint 400, and a second mounting assembly 500. In this embodiment, the carrier body 200 may be a carry-cot body 200. Left side and right side of the carry-cot body 200 are each provided with the rotational joint 400, two ends of the handle 300 are respectively fixed to the rotational joints 400 on the two sides of the carry-cot body 200, and the handle 300 is rotatable relative to the carry-cot body 200 through the two rotational joints 400. In this way, when the carry-cot needs to be moves, the handle 300 may be rotated to be vertically arranged relative to the carry-cot body 200, so as to facilitate the user to lift, as shown in FIG. 1 to FIG. 2. When the carry-cot is placed in a vehicle, the handle 300 can be rotated and folded relative to the carry-cot body 200, so as to be convenient for taking care of a baby, as shown in FIG. 3. In this embodiment, as shown in FIG. 6, outer sides of the two rotational joints 400, i.e., sides of the two rotational joints 400 away from the carry-cot body 200, are each provided with the second mounting assembly 500, two side object-holding devices 100 are also provided, and the two side object-holding devices 100 are arranged on the outer sides of the two rotational joints 400 respectively through the two second mounting assemblies 500. Certainly, in other embodiments, only one side object-holding device 100 may be provided, and the side object-holding device 100 may be arranged on either side of the carry-cot body 200. Preferably, the side object-holding device 100 may be arranged on one side of the carry-cot body 200 close to a door, such that the side object-holding device 100 can also have certain impact resistance in addition to storage. In addition, only one second mounting assembly 500 may be provided, and the second mounting assembly 500 may be arranged on either side of the carry-cot body 200 according to a requirement of the user.

Specific description below is based on the side object-holding device 100, the rotational joint 400, and the second mounting assembly 500 on either same side of the carry-cot body 200.

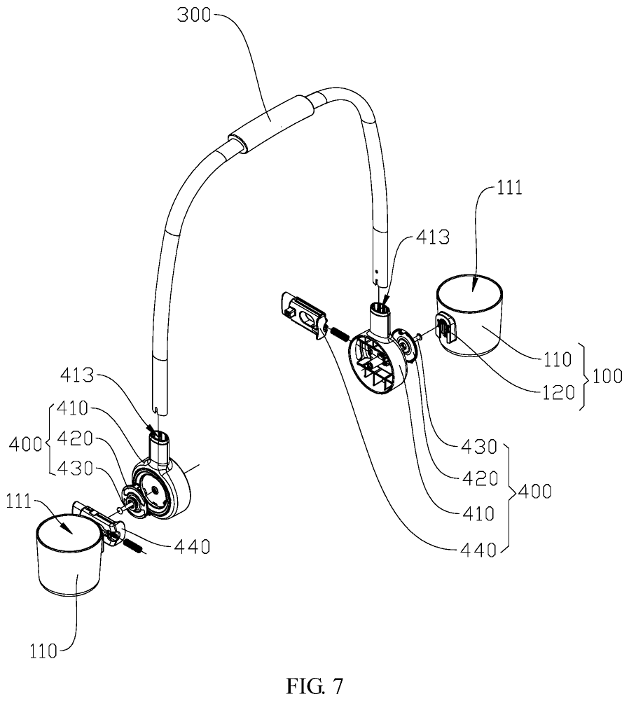

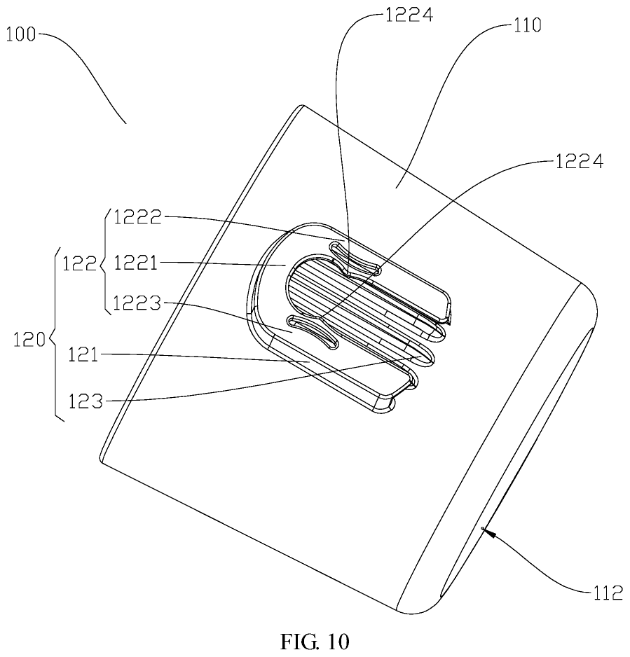

Specifically, as shown in FIG. 6, FIG. 7, and FIG. 10, the side object-holding device 100 includes an object holder 110 and a first mounting assembly 120. In this embodiment, the object holder 110 and the first mounting assembly 120 are integrally formed. Certainly, in other embodiments, the object holder 110 and the first mounting assembly 120 may be two separate components connected to each other. In this embodiment, the object holder 110 may be, for example, an object-holding cup. Certainly, in other embodiments, the object holder 110 may be an object-holding fixture, an object-holding rack, or the like, which is not limited. The object holder 110 has an accommodating cavity 111 for accommodating items such as a mobile phone or a water cup. In this embodiment, a bottom of the object holder 110 is also provided with a ventilation hole 112. In other embodiments, the ventilation hole 112 may be omitted.

In this embodiment, as shown in FIG. 10, the first mounting assembly 120 includes an engaging protrusion 121, an engaging border 122, and a limiting rib 123. The engaging protrusion 121 is fixed to an outer side wall of the object holder 110. In this embodiment, along a direction from an opening to the bottom of the object holder 110, the engaging protrusion 121 roughly has an inverted U-shaped structure. Certainly, in other embodiments, the engaging protrusion 121 may be in other shapes or arranged along other directions. The engaging border 122 is a U-shaped border, and a shape of an outer edge of the engaging border 122 matches a shape of the engaging protrusion 121. The outer edge of the engaging border 122 is fixed to the engaging protrusion 121 and is spaced apart from the outer side wall of the object holder 110, such that the engaging border 122 and the corresponding side wall of the object holder 110 form an accommodation space. The engaging border 122 includes an arc-shaped portion 1221, a first strip-shaped portion 1222, and a second strip-shaped portion 1223. The first strip-shaped portion 1222 and the second strip-shaped portion 1223 are connected to two ends of the arc-shaped portion 1221 respectively, and the first strip-shaped portion 1222 and the second strip-shaped portion 1223 are respectively provided with limiting protrusions 1224 that are oppositely arranged and extend towards each other. The limiting rib 123 is fixed to the side wall of the object holder 110 and located between the first strip-shaped portion 1222 and the second strip-shaped portion 1223. In this embodiment, the first mounting assembly 120 includes a plurality of limiting ribs 123, and the plurality of limiting ribs 123 are arranged along an extension direction of the first strip-shaped portion 1222 or the second strip-shaped portion 1223. In other embodiments, at least one limiting rib 123 is provided, an arrangement direction of the limiting rib 123 may also be perpendicular to the first strip-shaped portion 1222 or the second strip-shaped portion 1223, or the limiting rib 123 may be replaced with a limiting lump, or the like.

Specifically, as shown in FIG. 7 to FIG. 9, the rotational joint 400 includes a joint body 410, a decorative cover 420, a rotating shaft 430, and an operation button 440. The joint body 410 includes a rotating portion 411 and a mounting portion 412 connected to each other. In this embodiment, the rotating portion 411 and the mounting portion 412 are integrally formed. Certainly, in other embodiments, the rotating portion 411 and the mounting portion 412 may be two separate components connected to each other. The rotating portion 411 roughly has a cylindrical structure, and is rotatably connected to one side of the carry-cot body 200 through the rotating shaft 430.

As shown in FIG. 7 to FIG. 9, the operation button 440 may be pressed to be arranged on a side wall of the joint body 410. When the operation button 440 is pressed, the joint body 410 can rotate around the rotating shaft 430 relative to the carry-cot body 200. When the operation button 440 is released, the joint body 410 and the carry-cot body 200 are relatively fixed. The mounting portion 412 has an insertion slot 413, and one side of the handle 300 may be inserted into the insertion slot 413. The handle 300 may also be disassembled from the joint body 410 as required for maintenance or replacement.

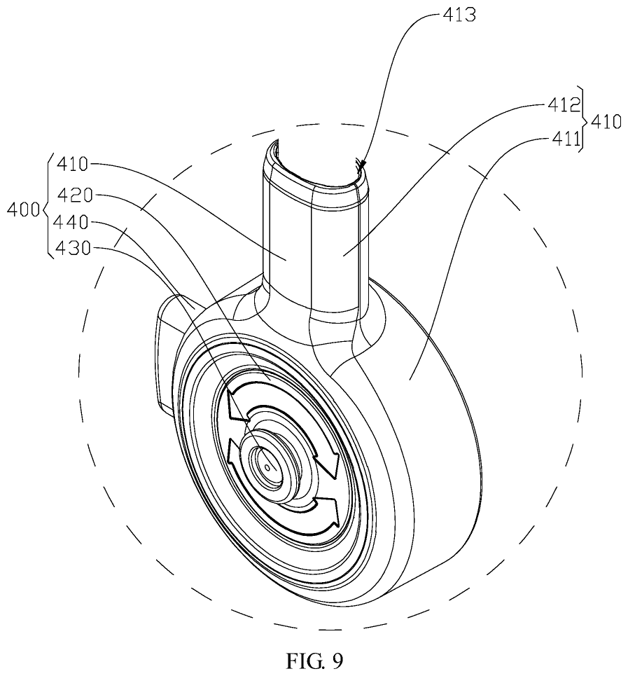

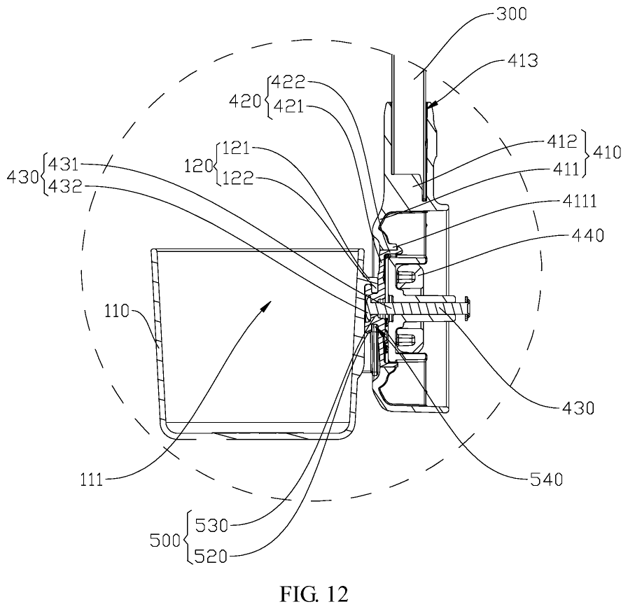

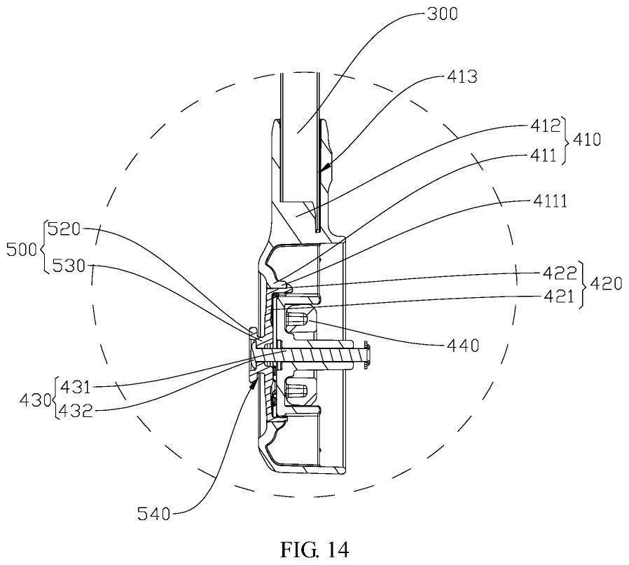

As shown in FIG. 9, FIG. 12, and FIG. 14, the decorative cover 420 is embedded on an outer end of the rotating portion 411, and the decorative cover 420 is substantially perpendicular to the rotating shaft 430. According to different arrangement manners of the second mounting assembly 500 described below, the decorative cover 420 may be selectively embedded in the rotating portion 411 in a rotatable or non-rotatable manner. Specifically, as shown in FIG. 12 and FIG. 14, the decorative cover 420 includes a decorative cover body 421 and an annular hook 422 connected to each other. The decorative cover body 421 is roughly in the shape of a disc, and the annular hook 422 is circumferentially arranged along an outer periphery of the decorative cover body 421. One side of the rotating portion 411 away from the carry-cot body 200 is provided with an annular bulge 4111. In this embodiment, the annular bulge 4111 extends towards a direction close to the carry-cot body 200. When the decorative cover 420 is embedded in the rotating portion 411, the annular hook 422 is snap-fitted with the annular bulge 4111 to prevent the decorative cover 420 from falling off. In this way, under the action of the annular hook 422 and the annular bulge 4111, an undercut structure is formed between the decorative cover 420 and the joint body 410, such that the decorative cover 420 can be stably mounted on the rotating portion 411. Certainly, the decorative cover 420 may alternatively be embedded in the rotating portion 411 by welding or riveting, which is not limited.

Optionally, the second mounting assembly 500 may be arranged in a variety of manners, provided that detachable cooperation with the first mounting assembly 120 can be realized. Detachable cooperation between the object holder 110 and the carry-cot body 200 is realized through the detachable cooperation between the first mounting assembly 120 and the second mounting assembly 500. Then, when the carry-cot body 200 is sold, the object holder 110 may be disassembled from the carry-cot body 200, such that a packaging volume of the carry-cot body 200 may not be increased, and the carry-cot body 200 meets a width requirement of relevant regulations. Certainly, if a width of the carry-cot body 200 on which the object holder 110 is mounted can meet the width requirement of relevant regulations, it may also be considered to arrange the object holder 110 on the carry-cot body 200 in a non-detachable manner.

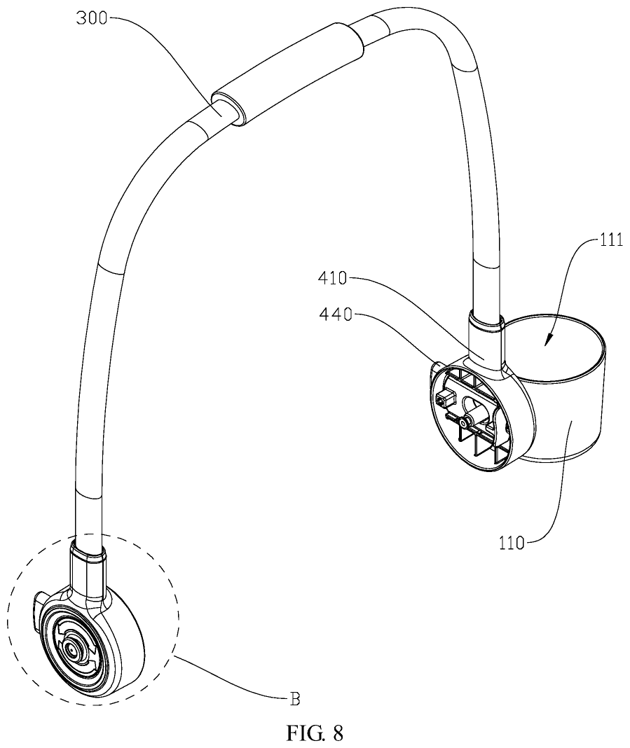

For example, in an embodiment, as shown in FIG. 8 to FIG. 14, the second mounting assembly 500 may include a stop ring 520 and a connecting portion 530. The connecting portion 530 is a cylindrical protrusion. A dimension of the connecting portion 530 in a direction parallel to a radial direction of the stop ring 520, that is, an outer diameter of the connecting portion 530, is smaller than an outer diameter of the stop ring 520. The connecting portion 530 has one end fixed to the decorative cover 420 and the other end fixed to the stop ring 520. In this way, the stop ring 520 and the decorative cover 420 are spaced apart and an annular engaging gap 540 is formed. The engaging border 122 can be engaged in the engaging gap 540. Moreover, when the engaging border 122 is engaged in the engaging gap 540, the stop ring 520 is partially located in the accommodation space, and the engaging border 122 can rotate around the annular engaging gap 540, such that the object holder 110 can rotate relative to the rotational joint 400. In this case, the stop ring 520 is roughly located in a range defined by the arc-shaped portion 1221 and the two limiting protrusions 1224, so as to prevent the object holder 110 from falling off during the rotation, especially when the object holder 110 rotates until a U-shaped opening of the engaging border 122 faces upwards. The limiting rib 123 is in interference fit with the stop ring 520 to ensure tightness of engagement between the second mounting assembly 500 and the stop ring 520 and to ensure stability of rotation of the object holder 110.

In this embodiment, the side object-holding device 100 is rotatable relative to the stop ring 520 and the decorative cover 420. Therefore, the decorative cover 420 may be fixedly embedded in the rotating portion 411. When the side object-holding device 100 is mounted on the rotational joint 400, if the handle 300 is rotated, for example, the handle 300 is rotated from a vertical state to a flat state, the object holder 110 may rotate, along with the rotation of the rotational joint 400, from a state where the opening of the object holder 110 faces upwards to a state where the opening of the object holder 110 faces downwards, the opening of the object holder 110 faces forwards, or the opening of the object holder 110 faces backwards, as shown in FIG. 3. In this case, the object holder 110 can be rotated manually, such that the engaging border 122 rotates around the annular engaging gap 540, and finally the object holder 110 is adjusted to a state where the opening of the object holder 110 faces upwards to facilitate placing objects.

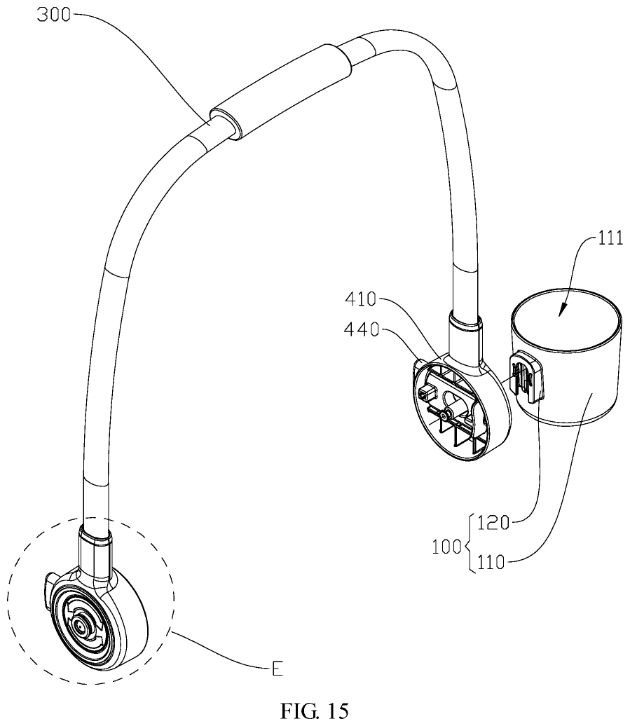

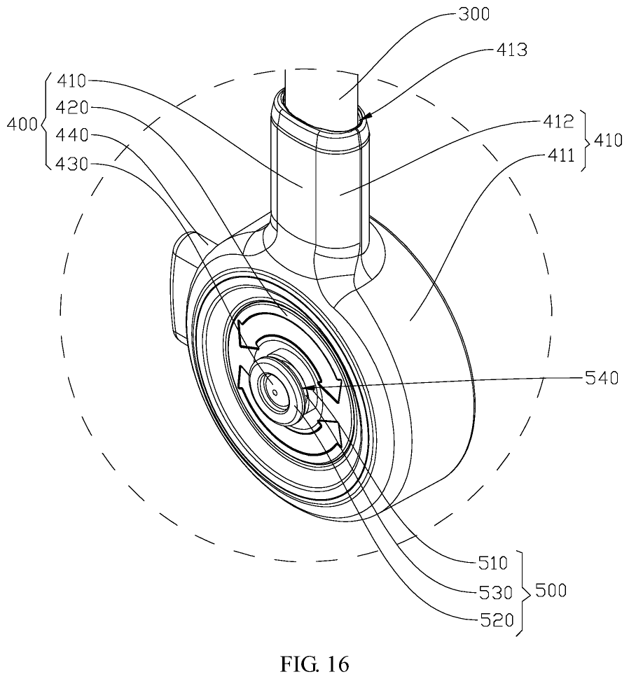

In another embodiment, as shown in FIG. 10, FIG. 15, and FIG. 16, in addition to the connecting portion 530 and the stop ring 520, the second mounting assembly 500 may also include a mounting protrusion 510. The mounting protrusion 510, the connecting portion 530, and the stop ring 520 are sequentially fixed to the decorative cover 420. The connecting portion 530 is a cylindrical protrusion. A dimension of the connecting portion 530 in a direction parallel to a radial direction of the stop ring 520, that is, a diameter of the connecting portion 530, is smaller than an outer diameter of the stop ring 520, and is also smaller than a radial dimension of the mounting protrusion 510. Then, the annular engaging gap 540 is formed between the stop ring 520 and the mounting protrusion 510. The engaging border 122 can be engaged in the engaging gap 540. Moreover, when the engaging border 122 is engaged in the engaging gap 540, the stop ring 520 is partially located in the accommodation space, and the engaging border 122 can rotate around the annular engaging gap 540, such that the object holder 110 can rotate relative to the rotational joint 400. In this case, the stop ring 520 is roughly located in a range defined by the arc-shaped portion 1221 and the two limiting protrusions 1224, so as to prevent the object holder 110 from falling off during the rotation, especially when the object holder 110 rotates until the U-shaped opening of the engaging border 122 faces upwards, as shown in FIG. 3. The limiting rib 123 is in interference fit with the stop ring 520 to ensure tightness of engagement between the second mounting assembly 500 and the stop ring 520 and to ensure stability of rotation of the object holder 110.

In this embodiment, the side object-holding device 100 is also rotatable relative to the stop ring 520, the mounting protrusion 510, and the decorative cover 420. Therefore, the decorative cover 420 may be fixedly embedded in the rotating portion 411. When the side object-holding device 100 is mounted on the rotational joint 400, if the handle 300 is rotated, for example, the handle 300 is rotated from a vertical state to a flat state, the object holder 110 may rotate, along with the rotation of the rotational joint 400, from a state where the opening of the object holder 110 faces upwards to a state where the opening of the object holder 110 faces downward or the opening of the object holder 110 faces forwards. In this case, the object holder 110 can be rotated manually, such that the engaging border 122 rotates around the annular engaging gap 540, and finally the object holder 110 is adjusted to a state where the opening of the object holder 110 faces upwards to facilitate placing objects.

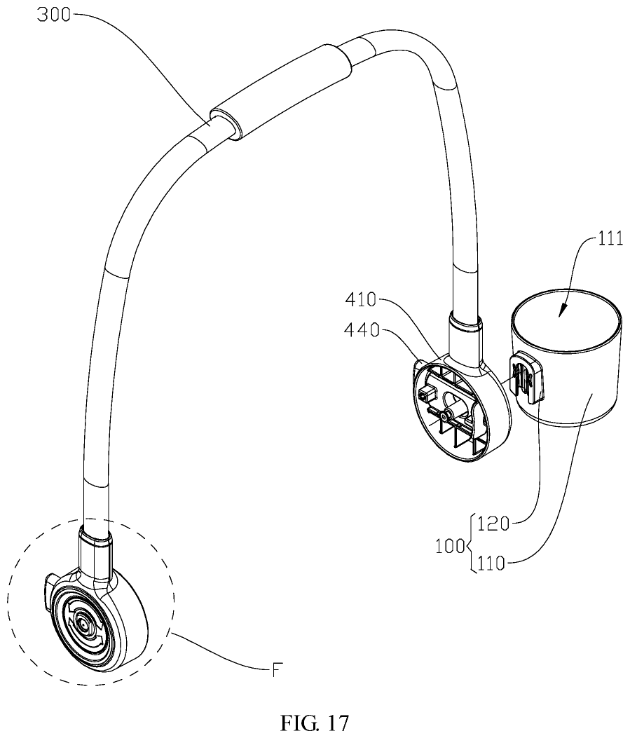

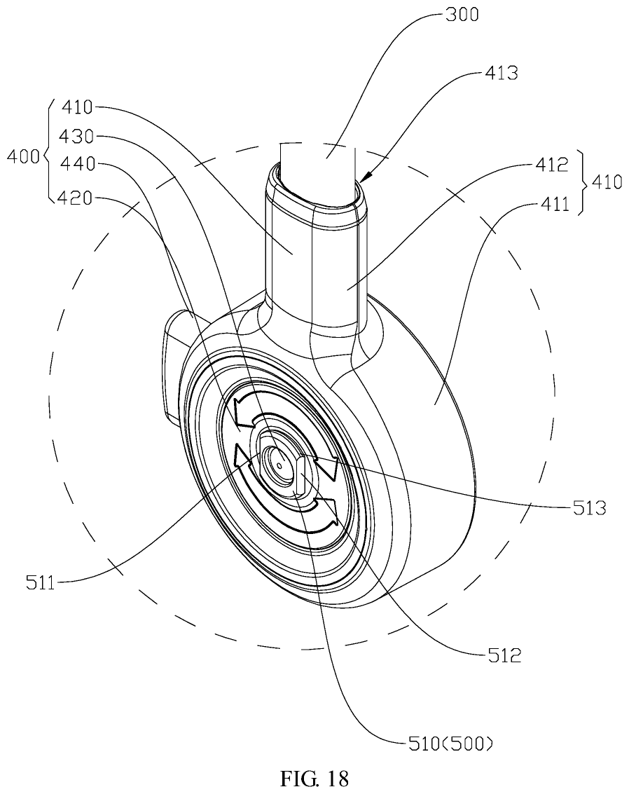

In yet another embodiment, as shown in FIG. 10, FIG. 17, and FIG. 18, the second mounting assembly 500 does not include the connecting portion 530 and the stop ring 520, but includes a mounting protrusion 510 arranged on the outer side of the rotational joint 400. The mounting protrusion 510 is fixed to the decorative cover 420. Two opposite sides of the mounting protrusion 510 have a first side edge 511 and a second side edge 512, and the mounting protrusion 510 also has an arc-shaped edge 513. Two ends of the arc-shaped side 513 are respectively connected to the first side edge 511 and the second side edge 512. An outer contour of the mounting protrusion 510 is substantially the same as an inner edge of the engaging border 122. The engaging border 122 can be snap-fitted with the mounting protrusion 510. In this case, the first strip-shaped portion 1222 abuts against the first side edge 511, the second strip-shaped portion 1223 abuts against the second side edge 512, and the mounting protrusion 510 is sandwiched between the two limiting protrusions 1224, so as to prevent the object holder 110 from falling off during the rotation, especially when the object holder 110 rotates until the U-shaped opening of the engaging border 122 faces upwards. The limiting rib 123 is in interference fit with the mounting protrusion 510 to ensure tightness of engagement between the second mounting assembly 500 and the mounting protrusion 510 and to ensure stability of rotation of the object holder 110.

In this way, the side object-holding device 100 is fixed relative to both the mounting protrusion 510 and the decorative cover 420. In this embodiment, the decorative cover 420 is rotatably embedded in the rotating portion 411. For example, a limiting ring groove (not shown in the drawings) may be provided on the rotating portion 411, and a side edge of the decorative cover 420 is snapped into the limiting ring groove such that the decorative cover 420 can rotate along the limiting ring groove, provided that the decorative cover 420 can be rotatably embedded in the rotating portion 411. In this way, when the side object-holding device 100 is mounted on the rotational joint 400, if the handle 300 is rotated, for example, the handle 300 is rotated from a vertical state to a flat state, the object holder 110 may rotate, along with the rotation of the rotational joint 400, from a state where the opening of the object holder 110 faces upwards to a state where the opening of the object holder 110 faces downwards, the opening of the object holder 110 faces forwards, or the opening of the object holder 110 faces backwards, as shown in FIG. 3. In this case, the object holder 110 can be rotated manually, such that the object holder 110 rotates relative to the joint body 410 through the first mounting assembly 120, the second mounting assembly 500, and the decorative cover 420, and finally the object holder 110 is adjusted to a state where the opening of the object holder 110 faces upwards to facilitate placing objects.

For the second mounting assembly 500 in this embodiment, the engaging border 122 in the first mounting assembly 120 can actually be omitted, provided that the engaging protrusion 121 having a U shape can be snap-fitted with the mounting protrusion 510.

In the above embodiments, the stop ring 520, the connecting portion 530 and the decorative cover 420, are integrally formed, or the stop ring 520, the connecting portion 530, the mounting protrusion 510, and the decorative cover 420 are integrally formed, or the connecting portion 530 and the decorative cover 420 are integrally formed. Certainly, in other embodiments, the above components may alternatively be independent of each other and connected in a detachable or non-detachable manner.

A mounting manner of the rotating shaft 430 is described below based on an embodiment in which the second mounting assembly 500 includes the stop ring 520 and the connecting portion 530. As shown in FIG. 9, FIG. 12, and FIG. 14, the rotating shaft 430 may include a pin portion 431 and an abutting portion 432 connected to one end of the pin portion 431. One end of the pin portion 431 away from the abutting portion 432 sequentially passes through the stop ring 520, the connecting portion 530, the decorative cover 420, and the rotating portion 411 to be pivotally connected to one side of the carry-cot body 200, and the abutting portion 432 abuts against one side of the connecting portion 530 away from the carry-cot body 200, to prevent the rotating shaft 430 from falling off and improve assembly stability of the handle 300 and the carry-cot body 200. As shown in FIG. 9, in this case, the abutting portion 432 is located in a central hole of the stop ring 520.

Certainly, in other embodiments, the first mounting assembly 120 and the second mounting assembly 500 may alternatively be in other forms. For example, the first mounting assembly 120 may be a pin provided on an outer wall of the object holder 110, and the second mounting assembly 500 may be a slot provided on the decorative cover 420, or the like, provided that the detachable cooperation between the first mounting assembly 120 and the second mounting assembly 500 can be realized.

The side object-holding device 100 and the carrier above have at least the following beneficial effects.

In the above side object-holding device 100, the object holder 110 can be mounted on the outer side of the rotational joint 400 of the carrier through the first mounting assembly 120. In this way, the user can place personal items such as a mobile phone or a water cup in the object-holding cavity 111 of the object holder 110. At the same time, when the carrier is impacted, the object holder 110 arranged on the outer side of the rotational joint 400 can also have a certain impact resistance effect, thereby reducing an impact force on an infant or a pet.

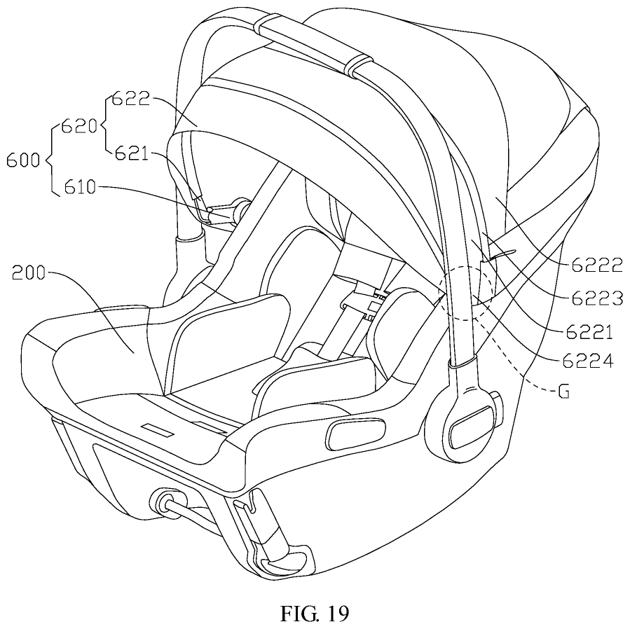

As shown in FIG. 19 to FIG. 29, in a second aspect, the present disclosure provides a carrier. The carrier further includes a canopy structure 600. Cloth of the canopy structure 600 can be fully unfolded or folded, such that the cloth has no wrinkles and is more upright when unfolded and is more compliant and takes up less space when folded, thereby making the carrier more beautiful and concise as a whole. Optionally, the carrier body 200 of the carrier may be a carry-cot, a sleeping box, a stroller, a safety seat, or the like. In this embodiment, the carrier body 200 is a carry-cot.

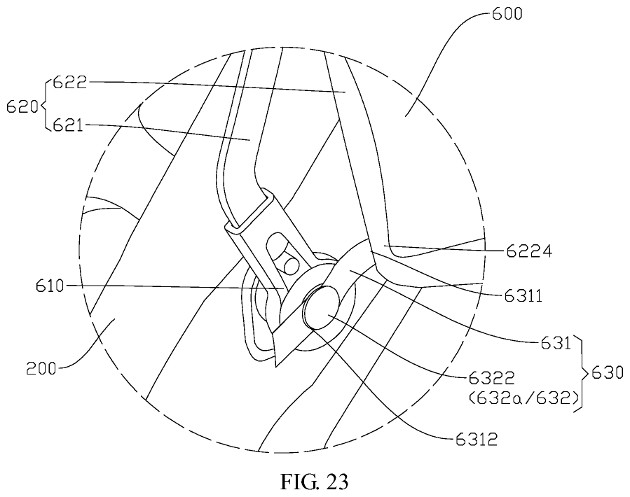

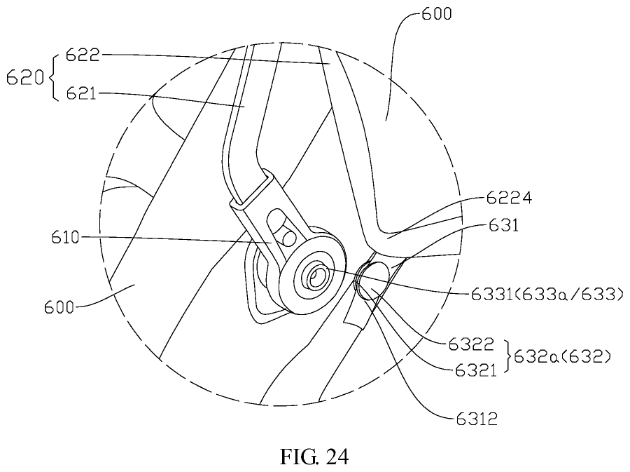

In an embodiment, as shown in FIG. 19, FIG. 23, and FIG. 24, the canopy structure 600 includes a mounting base 610, a canopy assembly 620, and a connection mechanism 630. The mounting base 610 is pivotably mounted on the carrier body 200. The canopy assembly 620 is connected to the mounting base 610 and is unfoldable or foldable with pivoting of the mounting base 610. The connection mechanism 630 is connected to the mounting base 610 and the canopy assembly 620 respectively.

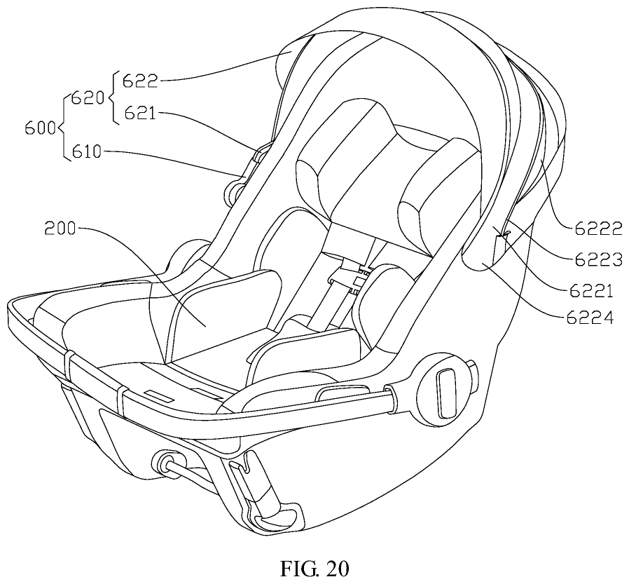

Specifically, referring to FIG. 19, FIG. 23, and FIG. 24, the canopy assembly 620 includes a canopy bracket 621 and cloth 622. The canopy bracket 621 is connected to the mounting base 610 and pivotable with the mounting base 610. The cloth 622 covers the canopy bracket 621. The cloth 622 is connected to the mounting base 610 through the connection mechanism 630, such that the cloth 622 is unfolded or folded with the pivoting of the mounting base 610. Specifically, the cloth 622 includes two bottom corners 6224 respectively located on two sides of the carrier body 200, and the two bottom corners 6224 can be connected to the carrier body 200 through the connection mechanism 630 respectively. In this way, the cloth 622, when pivoting with the mounting base 610, has a larger movement space and movement stroke, such that the cloth 622 can be fully unfolded or folded (refer to FIG. 20 to FIG. 22).

Referring to FIG. 19, the cloth 622 includes a first piece of cloth 6221 and a second piece of cloth 6222, and the first piece of cloth 6221 covers the canopy bracket 621 and is detachably connected to the second piece of cloth 6222 through a fastener 6223. Optionally, the fastener 6223 includes a zipper, a hook and loop fastener, a snap button, or a connecting hook. In this embodiment, the fastener 6223 is a zipper. The first piece of cloth 6221 and the second piece of cloth 6222 of the cloth 622 are detachably connected, so as to construct the cloth 622 in various shapes required by the user and also make it easy to mount the cloth 622 on the carrier body 200.

In an embodiment, as shown in FIG. 19, FIG. 23, and FIG. 24, two connection mechanisms 630 are provided, and the two connection mechanisms 630 are arranged on the two sides of the carrier body 200 respectively. For ease of description, the following illustration is based on an example in which the connection mechanism 630 is located on one side of the carrier body 200.

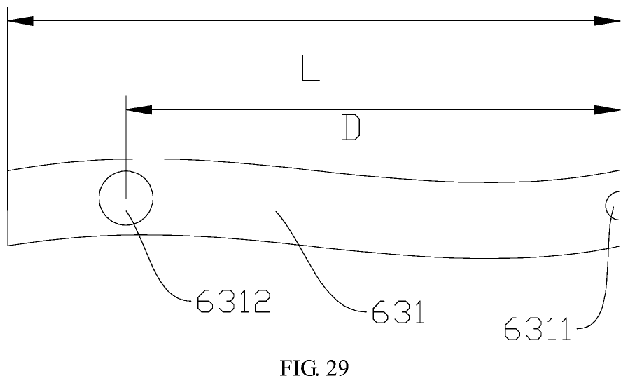

As shown in FIG. 23 and FIG. 24, the connection mechanism 630 according to an embodiment of the present disclosure includes a connector 631, a first fixing member 632, and a second fixing member 633. (Refer to FIG. 29 together) The connecting member 631 includes a connecting portion 6311 and a fixing portion 6312 spaced apart. In this embodiment, the connecting portion 6311 is formed at one end of the connector 631, and the fixing portion 6312 is formed at the other end of the connector 631. The connecting portion 6311 is configured to be connected to the canopy assembly 620. The fixing portion 6312 is detachably connected to the mounting base 610 through the first fixing member 632 and the second fixing member 633. The first fixing member 632 is arranged on the fixing portion 6312 of the connector 631. The second fixing member 633 is arranged on the mounting base 610 and is detachably connected to the first fixing member 632. In this embodiment, the connector 631 has a strip-shaped structure, and the connecting portion 6311 and the fixing portion 6312 are roughly located on two end portions of the connector 631.

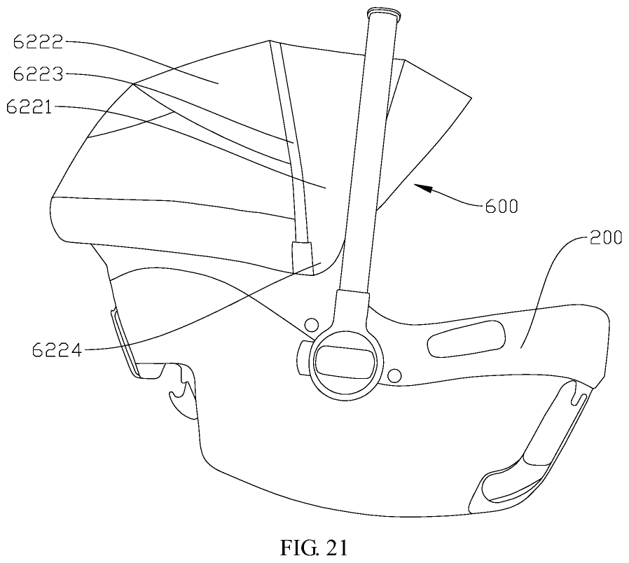

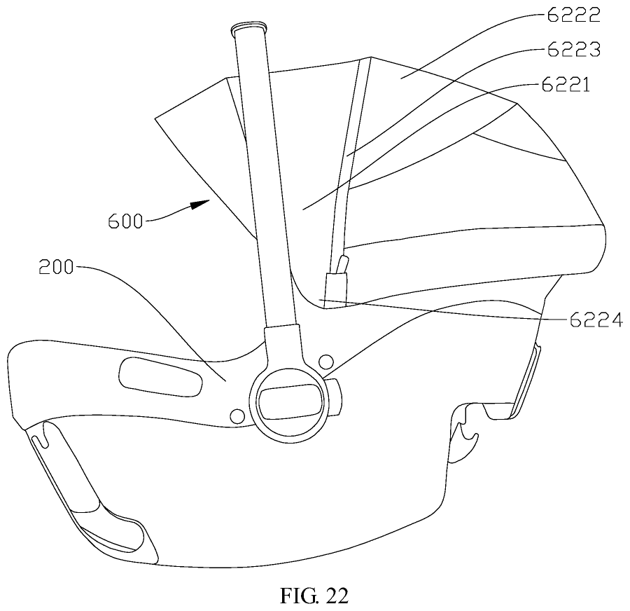

Through the arrangement of the connection mechanism 630 in the present disclosure, when the canopy bracket 621 pivots with the mounting base 610, the movement stroke is larger, which increases the movement space of the cloth 622 in the unfolding and folding, such that the cloth 622 can be fully unfolded or folded, and the cloth 622 has no wrinkles and is more upright when unfolded (refer to FIG. 19, FIG. 21, and FIG. 22) and is more compliant and takes up less space when folded (refer to FIG. 20), thereby making the carrier more beautiful and concise as a whole.

Referring to FIG. 23 and FIG. 24, the connector 631 is a flexible connector. Optionally, the flexible connector is a connecting webbing or a connecting rope. In this embodiment, the connector 631 is a connecting webbing, which takes up little space and is cheap and easily available. The connecting portion 6311 of the connector 631 is connected to the cloth 622 of the canopy assembly 620. Specifically, the connecting portion 6311 is connected to the bottom corner 6224 of the cloth 622. The connecting portion 6311 is fixedly connected to the cloth 622 of the canopy assembly 620, or the connecting portion 6311 is detachably connected to the cloth 622 of the canopy assembly 620. In this embodiment, the connecting portion 6311 is fixedly connected to the cloth 622. Specifically, the connecting portion 6311 is fixedly connected to the cloth 622 of the canopy assembly 620 by stitching (for example, sewing). Certainly, in other embodiments, the detachable connection between the connecting portion 6311 and the cloth 622 of the canopy assembly 620 may alternatively be realized by arranging a pair of snap buttons, a pair of hook and loop fasteners, or a fixing hole (ring or groove) and a fixing post (hook) that can fit each other therebetween.

Optionally, the first fixing member 632 and the second fixing member 633 may be in various forms.

For example, in a first embodiment, as shown in FIG. 23 and FIG. 24, the first fixing member 632 may include a first snap button 632a, and the second fixing member 633 may include a second snap button 633a that can be snap-fitted with the first snap button 632a. The second snap button 633a is fixedly arranged on the mounting base 610. Specifically, the second snap button 633a is fixedly arranged on a pivot shaft of the mounting base 610. The second snap button 633a has a female fastening portion 6331 protruding from the mounting base 610 for easy connection with the first snap button 632a. The first snap button 632a has a male fastening portion 6321 and a pressing surface 6322. The male fastening portion 6321 is arranged on a surface of the connector 631 facing the mounting base 610, and the pressing surface 6322 is arranged on a surface of the connector 631 away from the mounting base 610, such that the first snap button 632a can be firmly arranged on the connector 631. In this embodiment, the first snap button 632a may be fixedly arranged on the connector 631 by a dotter. Part of the second snap button 633a is embedded in the mounting base 610, such that the second snap button 633a can be firmly connected to the mounting base 610, thereby reducing a possibility that the second snap button 633a falls off from the mounting base 610 after the second snap button 633a is repeatedly engaged with or disengaged from the first snap button 632a. Certainly, in other embodiments, the first snap button 632a and the second snap button 633a may alternatively be arranged reversely. That is, the second fixing member 633 may include the first snap button 632a, the first snap button 632a may be fixed to the mounting base 610, the first fixing member 632 may include the second snap button 633a, and the second snap button 633a is fixed to the connector 631.

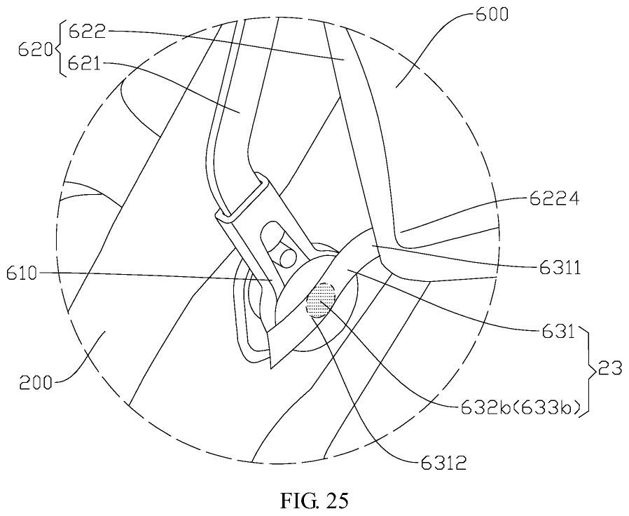

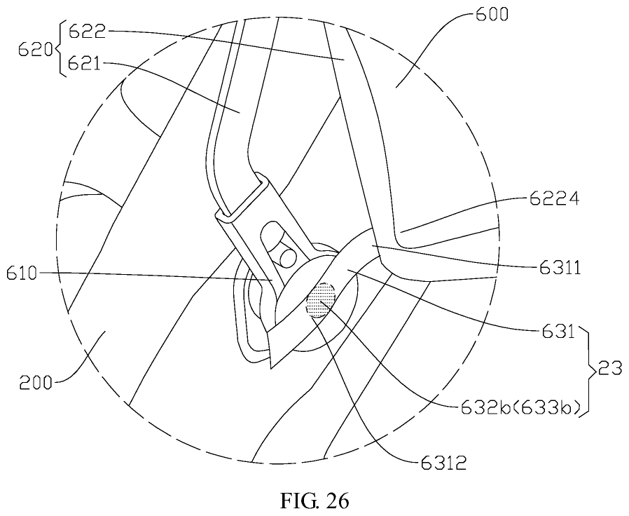

In a second embodiment, as shown in FIG. 25 and FIG. 26, the first fixing member 632 may include a first hook and loop fastener 632b having a loop surface, the second fixing member 633 may include a second hook and loop fastener 633b having a hook surface, and the first hook and loop fastener 632b and the second hook and loop fastener 633b can be bonded to each other. The second hook and loop fastener 633b may be fixed to the mounting base 610 by, for example, adhesion. The first hook and loop fastener 632b may be fixed to the connector 631 by adhesion, stitching, or the like. The first hook and loop fastener 632b is adhered to the second hook and loop fastener 633b, such that the connector 631 is detachably connected to the mounting base 610. Certainly, in other embodiments, the first hook and loop fastener 632b and the second hook and loop fastener 633b may alternatively be arranged reversely. That is, the second fixing member 633 may include the first hook and loop fastener 632b, the first hook and loop fastener 632b may be fixed to the mounting base 610, the first fixing member 632 may include the second hook and loop fastener 633b, and the second hook and loop fastener 633b is fixed to the connector 631.

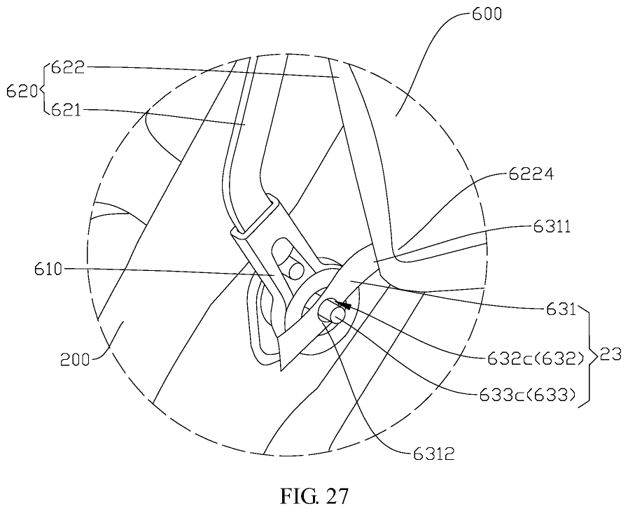

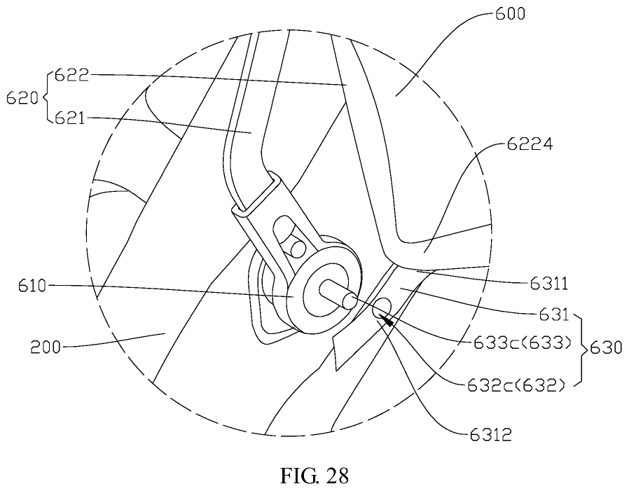

In a third embodiment, referring to FIG. 27 and FIG. 28, one of the first fixing member 632 and the second fixing member 633 includes a fixing hole 632c or a hanging loop. The other of the first fixing member 632 and the second fixing member 633 includes a fixing post 633c or a hook. In this embodiment, the fixing portion 6312 of the connector 6312 is provided with the fixing hole 632c or the hanging loop (not shown in the drawings). The fixing hole 632c or the hanging loop forms the first fixing member 632, the mounting base 610 is provided with the fixing post 633c that can be in insertion fit with the fixing hole 632c or the hanging loop, and the fixing post 633c forms the second fixing member 633. The fixing post 633c is inserted into the fixing hole 632c or the hanging loop, to realize the detachable connection between the first fixing member 632 and the second fixing member 633. In other embodiments, the connector 631 may be provided with the fixing hole 632c or the hanging loop (not shown in the drawings). The fixing hole 632c or the hanging loop forms the first fixing member 632, the mounting base 610 is provided with a hook (not shown in the drawings) that can be hooked on the fixing hole 632c or the hanging loop, and the hook forms the second fixing member 633. The hook is hooked on the fixing hole 632c or the hanging loop, to realize the detachable connection between the first fixing member 632 and the second fixing member 633.

In some other unshown embodiments, the connecting portion 6311 of the connector 631 may be connected to the mounting base 610. Optionally, the connecting portion 6311 may be fixedly connected to the mounting base 610 by sewing, adhesion, or the like. Alternatively, the connecting portion 6311 may be detachably connected to the mounting base 610 through, for example, a pair of snap buttons or a pair of hook and loop fasteners. In this embodiment, the connecting portion 6311 and the mounting base 610 are connected by sewing. The fixing portion 6312 is connected to the cloth 622 of the canopy assembly 620. Optionally, the fixing portion 6312 is detachably connected to the cloth 622 of the canopy assembly 620. Further, the first fixing member 632 is arranged on the fixing portion 6312, and the second fixing member 633 is arranged on the cloth 622 of the canopy assembly 620. In this way, the connector 631 realizes, through the first fixing member 632 arranged on the fixing portion 6312 thereof, a detachable connection with the second fixing member 633 arranged on the cloth 622 of the canopy assembly 620. Specific forms of the first fixing member 632 and the second fixing member 633 may be obtained with reference to the above embodiments, which are not described in detail herein.

In some embodiments, as shown in FIG. 29, the connector 631 includes a connecting portion 6311 and a fixing portion 6312 spaced apart. The connecting portion 6311 is formed at one end of the connector 631, and the fixing portion 6312 is formed at the other end of the connector 631. Further, the connector 631 has a strip-shaped structure, and the connecting portion 6311 and the fixing portion 6312 are roughly located on two end portions of the connector 631. A length L of the connector 631 may range from 1.2 inches to 3 inches. A distance D from the connecting portion 6311 to the fixing portion 6312 ranges from 1 inch to 2 inches. Specifically, the length L of the connector 631 is 2 inches, and the distance D from the connecting portion 6311 to the fixing portion 6312 is 1.37 inch. In this way, the movement space and the movement stroke of the cloth 622 moving with the canopy bracket 621 are guaranteed when the canopy bracket 621 rotates with the mounting base 610, and the connector 631 can be operated conveniently to separate or connect the first fixing member 632 from or to the second fixing member 633.

The carrier, the canopy structure 600, and the connection mechanism 630 above have at least the following technical effects.

Through the arrangement of the connection mechanism 630, when the canopy assembly 620 pivots with the mounting base 610, the movement stroke is larger, which increases the movement space of the cloth 622 of the canopy assembly 620 in the unfolding and folding, such that the cloth 622 can be fully unfolded or folded, and the cloth 622 has no wrinkles and is more upright when unfolded and is more compliant and takes up less space when folded, thereby making the carrier more beautiful and concise as a whole.

The technical features in the above embodiments may be randomly combined. For concise description, not all possible combinations of the technical features in the above embodiments are described. However, all the combinations of the technical features are to be considered as falling within the scope described in this specification provided that they do not conflict with each other.

The above embodiments only describe several implementations of the present disclosure, and their description is specific and detailed, but cannot therefore be understood as a limitation on the patent scope of the application. It should be noted that those of ordinary skill in the art may further make variations and improvements without departing from the conception of the present disclosure, and these all fall within the protection scope of the present disclosure. Therefore, the patent protection scope of the present disclosure should be subject to the appended claims.

What is claimed is:

1. A side object-holding device, applied to a carrier, comprising:
an object holder; and
a first mounting assembly arranged on an outer wall of the object holder, the object holder being mounted on an outer side of a rotational joint of the carrier through the first mounting assembly.

2. The side object-holding device according to claim 1, wherein the object holder is detachably mounted on the outer side of the rotational joint of the carrier through the first mounting assembly.

3. The side object-holding device according to claim 2, wherein the carrier further comprises a second mounting assembly arranged on the rotational joint, the first mounting assembly comprises an engaging protrusion having a U shape arranged on a side wall of the object holder, and the engaging boss is configured to engage with the second mounting assembly.

4. The side object-holding device according to claim 3, wherein the first mounting assembly further comprises an engaging border having a U shape, a shape of an outer edge of the engaging border matches a shape of the engaging protrusion, the outer edge of the engaging border is fixed to the engaging protrusion such that the engaging border and the side wall of the object holder form an accommodation space, and the engaging border is configured to engage with the second mounting assembly.

5. The side object-holding device according to claim 4, wherein the engaging border comprises an arc-shaped portion, a first strip-shaped portion, and a second strip-shaped portion, the first strip-shaped portion and the second strip-shaped portion is connected to two ends of the arc-shaped portion respectively, and the first strip-shaped portion and the second strip-shaped portion are respectively provided with limiting protrusions that are oppositely arranged and extend towards each other.

6. The side object-holding device according to claim 5, wherein the first mounting assembly further comprises a limiting rib, and the limiting rib is fixed to the side wall of the object holder and is located between the first strip-shaped portion and the second strip-shaped portion.

7. The side object-holding device according to claim 6, wherein the limiting rib is arranged along an extension direction of the first strip-shaped portion or the second strip-shaped portion.

8. The side object-holding device according to claim 6, wherein at least one limiting rib is provided.

9. A carrier, comprising:
a rotational joint;
a second mounting assembly arranged on an outer side of the rotational joint; and
a side object-holding device comprising an object holder and a first mounting assembly, the first mounting assembly being arranged on an outer wall of the object holder;
wherein the object holder is capable of being mounted on the outer side of the rotational joint through cooperation between the first mounting assembly and the second mounting assembly.

10. The carrier according to claim 9, wherein the first mounting assembly detachably cooperates with the second mounting assembly.

11. The carrier according to claim 10, wherein the first mounting assembly comprises an engaging protrusion having a U shape and an engaging border having a U shape, a shape of an outer edge of the engaging border matches a shape of the engaging protrusion, the engaging protrusion is arranged on a side wall of the object holder, the outer edge of the engaging border is fixed to the engaging protrusion such that the engaging border and the side wall of the object holder form an accommodation space, the second mounting assembly has an engaging gap, and the engaging border is engaged in the engaging gap.

12. The carrier according to claim 11, wherein the second mounting assembly comprises a stop ring, the stop ring is spaced apart from the outer side of the rotational joint to form the engaging gap, and when the engaging border is engaged in the engaging gap, the stop ring is partially located in the accommodation space.

13. The carrier according to claim 12, wherein the engaging border comprises an arc-shaped portion, a first strip-shaped portion, and a second strip-shaped portion, the first strip-shaped portion and the second strip-shaped portion are connected to two ends of the arc-shaped portion respectively, the first strip-shaped portion and the second strip-shaped portion are respectively provided with limiting protrusions that are oppositely arranged and extend towards each other, and when the engaging border is engaged in the engaging gap, the stop ring is partially located in a range defined by the arc-shaped portion and the two limiting protrusions.

14. The carrier according to claim 13, wherein the first mounting assembly further comprises a limiting rib, the limiting rib is fixed to the side wall of the object holder and is located between the first strip-shaped portion and the second strip-shaped portion, and when the engaging border is engaged in the engaging gap, the limiting rib is in interference fit with the stop ring.

15. The carrier according to claim 12, wherein the second mounting assembly further comprises a connecting portion, two ends of the connecting portion are connected to the outer side of the rotational joint and the stop ring respectively, and a dimension of the connecting portion in a direction parallel to a radial direction of the stop ring is smaller than an outer diameter of the stop ring.

16. The carrier according to claim 11, wherein the second mounting assembly comprises a mounting protrusion and a stop ring, the mounting protrusion is fixed to the outer side of the rotational joint, the stop ring is spaced apart from the mounting protrusion to form the engaging gap, and when the engaging border is engaged in the engaging gap, the stop ring is partially located in the accommodation space.

17. The carrier according to claim 16, wherein the second mounting assembly further comprises a connecting portion, two ends of the connecting portion are connected to the mounting protrusion and the stop ring respectively, and a dimension of the connecting portion in a direction parallel to a radial direction of the stop ring is smaller than an outer diameter of the stop ring.

18. The carrier according to claim 10, wherein the second mounting assembly comprises a mounting protrusion arranged on the outer side of the rotational joint, and the mounting protrusion detachably cooperates with the first mounting assembly.

19. The carrier according to claim 18, wherein the first mounting assembly comprises an engaging protrusion having a U shape arranged on a side wall of the object holder, and the mounting protrusion is capable of being snap-fitted with the object holder.

20. The carrier according to claim 18, wherein the first mounting assembly comprises an engaging protrusion having a U shape and an engaging border having a U shape, an outer edge of the engaging border matches a shape of the engaging protrusion, the engaging protrusion is arranged on a side wall of the object holder, the outer edge of the engaging border is fixed to the engaging protrusion, and the engaging border is capable of being snap-fitted with the mounting protrusion.

21. The carrier according to claim 20, wherein the engaging border comprises an arc-shaped portion, a first strip-shaped portion, and a second strip-shaped portion, the first strip-shaped portion and the second strip-shaped portion are connected to two ends of the arc-shaped portion respectively, two sides of the mounting protrusion have a first side edge and a second side edge, and when the engaging border is snap-fitted with the mounting protrusion, the first strip-shaped portion abuts against the first side edge, and the second strip-shaped portion abuts against the second side edge.

22. The carrier according to claim 18, wherein the rotational joint comprises a joint body and a decorative cover rotatably arranged on the joint body, and the mounting protrusion is fixed to the decorative cover.

23. The carrier according to claim 9, wherein the carrier is a carry-cot, the carrier further comprises a carry-cot body and a handle, two sides of the carry-cot body are each provided with the rotational joint and the second mounting assembly, two ends of the handle are respectively mounted on the rotational joints on the two sides of the carry-cot body, and the handle is rotatable relative to the carry-cot through the rotational joint.

24. The carrier according to claim 23, wherein at least one side object-holding device is provided, and the side object-holding device is mounted on the second mounting assembly on at least one side of the carry-cot body.

25. The carrier according to claim 23, further comprising a rotating shaft, and the rotational joint is rotatably connected to the carry-cot body through the rotating shaft.

26. The carrier according to claim 9, comprising:
a carrier body, and
a canopy structure comprising:
a mounting base configured to be pivotably mounted on the carrier body;
a canopy assembly connected to the mounting base and unfoldable or foldable with pivoting of the mounting base; and
a connection mechanism comprising:
a connector having a connecting portion and a fixing portion spaced apart, the connecting portion being configured to be connected to one of the canopy assembly and the mounting base;
a first fixing member arranged on the fixing portion; and
a second fixing member arranged on the other of the canopy assembly and the mounting base and detachably connected to the first fixing member.

27. A canopy structure, comprising:
a mounting base;
a canopy assembly, connected to a mounting base and unfolded or folded with pivoting of the mounting base; and
a connection mechanism comprises:
a connector having a connecting portion and a fixing portion spaced apart, the connecting portion being configured to be connected to one of the canopy assembly and the mounting base;
a first fixing member arranged on the fixing portion; and
a second fixing member arranged on the other of the canopy assembly and the mounting base and detachably connected to the first fixing member.

28. The canopy structure according to claim 27, wherein the connecting portion is configured to be connected to cloth of the canopy assembly, and the second fixing member is arranged on the mounting base.

29. The canopy structure according to claim 28, wherein the connecting portion is configured to be connected to a bottom corner of the cloth of the canopy assembly.

30. The canopy structure according to claim 29, wherein the connecting portion is configured to be fixedly connected to the cloth of the canopy assembly; or the connecting portion is configured to be detachably connected to the cloth of the canopy assembly.

31. The canopy structure according to claim 28, wherein the connecting portion is fixedly connected to the cloth of the canopy assembly by stitching.

32. The canopy structure according to claim 27, wherein the connector is a flexible connector; the flexible connector is a connecting webbing or a connecting rope.

33. The canopy structure according to claim 27, wherein a length of the connector ranges from 1.2 inches to 3 inches; a distance from the connecting portion to the fixing portion ranges from 1 inch to 2 inches.

34. The canopy structure according to claim 27, wherein the first fixing member and the second fixing member comprise a pair of snap buttons capable of being fastened to each other; or the first fixing member and the second fixing member comprise a pair of hook and loop fasteners capable of being bonded to each other.

35. The canopy structure according to claim 27, wherein one of the first fixing member and the second fixing member comprises a fixing hole or a hanging loop; and the other of the first fixing member and the second fixing member comprises a fixing post or a hook.

36. The canopy structure according to claim 27, wherein the fixing portion is formed at one end of the connector, and the connecting portion is formed at the other end of the connector.

37. The canopy structure according to claim 27, wherein the mounting base is configured to be pivotally mounted on a carrier body.

38. The canopy structure according to claim 37, wherein the canopy assembly comprises:
a canopy bracket connected to the mounting base and pivotable with the mounting base; and
cloth covering the canopy bracket and connected to the connecting portion;
wherein the cloth is connected to the mounting base through the connection mechanism, such that the cloth is unfolded or folded with the pivoting of the mounting base.
